(19) United States
(12) Patent Application Publication
(10) Pub. No.: US 2004/0268225 A1
(43) Pub. Date: Dec. 30, 2004

(54) Method and system for controlling navigation of a graphical user interface

(76) Inventors: Raymond V. Walsh, Newton, MA (US); Alexander Firshein, Boston, MA (US); Peter Richardson, Chestnut Hill, MA (US)

Correspondence Address: BARLOW, JOSEPHS & HOLMES, LTD., 101 DYER STREET, 5TH FLOOR, PROVIDENCE, RI, 02903, US

(21) Appl. No.: 10/873,343

(22) Filed: Jun. 21, 2004

Related U.S. Application Data
(60) Provisional application No. 60/482,705, filed on Jun. 26, 2003.

(51) Int. Cl. G06F 17/00

(52) U.S. Cl. 715/501.1

(57) ABSTRACT

The present invention provides a new and unique method of controlling web page navigation by a user. The method of the present invention easily modifies the web page (56) without altering the underlying HTML code of the page (56). The JavaScript program controls the overall navigation experience according to a pre-programmed set of Actions (111) and user interface elements. The authoring component (60) of the invention enables creation of the JavaScript assist program according to the desired help or demonstration features. Most importantly, each of the web objects (100) that are linked to a particular event (111) and action are uniquely and specifically identified so that a given event or action will be executed upon interaction with a web object (100) regardless of where that web object (100) appears on the web page (56) or web site. Thus, the control of navigation of web objects (100) survives across web pages (56) even if those underlying web pages (56) are modified.

### CROSS-REFERENCE TO RELATED APPLICATION

This application claims the benefit of U.S. Provisional Patent Application Ser. No. 60/482,705, filed June 26, 2003.

### BACKGROUND OF THE INVENTION

The present invention relates generally to the use of computers by a user. In particular, the present invention relates to the controlled navigation of a web site or an application accessed through an HTML-based graphical user interface (GUI). The present invention has particular application in the control of web pages written in Hypertext Mark-up language, known as HTML.

To make the Internet more accessible and usable, a protocol known as the “World Wide Web” (WWW) was developed to provide an easier and user-friendlier interface for the Internet. With the World Wide Web, an entity having a domain name creates a “web page” or “page” that can provide information and, to a limited degree, some interactivity for the user.

A computer user can “browse”, i.e. navigate around, the WWW by utilizing a suitable web browser and a network gateway, such as an Internet Service Provider (ISP). Currently, popular web browsers, include Netscape® Navigator®. made by Netscape Corporation of Mountain View, Calif., and Internet Explorer made by Microsoft®. Corporation of Redmond, Wash. A web browser allows a user to specify or search for a web page on the WWW, and then retrieves and displays web pages on the user's computer screen. It has also become well known and extremely popular to closed-ended private networks, called Intranets or wide area networks (WAN), which are not readily accessible by the public. The only difference is the scope of users that can access the network and nature of the interconnection of the users on the network. In general, all of these networks, the user has access to a web page via a web browser. It is also possible for a standalone machine to access and browse web pages that reside locally thereon.

The Internet, as well as most networks, is based upon a transmission protocol known as “Transmission Control Protocol/Internet Protocol” (or “TCP/IP” for short), which sends “packets” of data between a host machine, e.g. a server computer on the Internet, and a client machine, e.g. a user's personal computer connected to the Internet. The WWW is an Internet interface protocol that is supported by the same TCP/IP transmission protocol. The Intranets discussed above are private networks based upon Internet standards since they adhere to Internet standards, can often use the same web browser software and web server software as are used on the Internet.

A web page typically includes static images, animated images (e.g. video), and/or text. A web page can also include fill-in web based forms for the collection of data. These items can be generally referred to as “web objects”. Typically, these web objects, such as images and text, are specified in file written in HTML that is sent from the web server to the client machine. This HTML file is parsed by the web browser in order to display the text and images on the display of the client machine. Other standardized languages or protocols are also being developed for use with the Internet and the World Wide Web. For example, various plug-in applications are available that can reside within an HTML page. Plug-ins are application programs running in conjunction with certain web browsers to parse plug-in-specific code in the web page that the browser cannot understand. For example, these plug-ins include Flash® objects from Macromedia Corporation for generating animations and embedded audio and video objects from the Media Player from Microsoft®.

Furthermore, additional functionality may be provided in web pages with information downloaded over the WWW in the form of scripts or programs. Scripting, typically in the form of VBScript or JavaScript, allows a series of instructions to be performed on the client computer once the instructions have been downloaded in a web page. Programs can be provided in such standard languages as Visual Basic, C++, or currently in the form of Java “applets” or ActiveX®. controls.

Java is a well known cross-platform language that can run in any web browser. It includes a platform-independent interpreter running on the client machine that executes downloaded applets within web pages or other programs, e.g., to display animated images, retrieve data over the WWW, output feedback to the user, or perform operating system tasks. ActiveX controls similarly execute on the client computer once the program instructions are resident on the client. ActiveX controls are programmable acts that can be embedded into Web pages and may be written in any (platform-specific) language. Java and ActiveX controls can add functionality to a Web page that would normally be difficult, or even impossible, using HTML or scripting languages. ActiveX controls can also be controlled with a scripting language.

Still further, other WWW-related functionality includes Dynamic HTML. Dynamic HTML is a set of features currently incorporated in browsers, such as Microsoft Internet Explorer, that enable authors to dynamically change the rendering and content of an HTML document. Using Dynamic HTML, a content developer or programmer can access the attributes of a document's contents or objects (such as an object's position on the page and type). In addition, event messages are generated when a user interacts with the web page content (such as when a user clicks on a graphical button image). The features of Dynamic HTML can be elicited through the use of VBScript or JavaScript scripts embedded in a Web page or programmatically through Visual Basic or C++.

In view of the foregoing, it is very common for web pages containing web objects to be delivered to a user via a web browser in a static non-dynamic manner. For example, a web site is typically delivered with text and accompanying graphical objects for viewing by the user. Such a static web navigation experience for the user severely limits the use of the WWW as a means for delivering and collecting information. Moreover, the typical non-interactive nature of the WWW makes it difficult to maintain the user's attention when navigating a given web page.

In the computer industry, as is well known in the prior art, there is a need to provide to the user a more interactive environment during the navigation of a given web page and even an entire web site. There may be a need to change the web site so it delivers on-the-fly instructive help to the user. In this case, there is a desire to deliver, for example, a context-specific pop up help box to assist a user during navigation of a web site. Such help may assist a user fill in a form on a web site for data entry.

Also, there may be a need to operate a web page or an entire the site so that it operates in a demonstration mode only. In this case, a web browser could be used for data entry by an employee where there is a desire to first train the employee on use of the web site before permitting the employee to actually use the site in a live condition.

In the prior art, the common method for delivering on-the-fly help to a user is to use typical HTML tools to modify all of the actual pages that reside within the site to change them to deliver, for example, the desired help. When a user navigates to a given web page within a site, HTML code may be added to the web page to automatically launch a child pop-up help window to provide the help or assistance. This method of delivering interactive help requires that the underlying HTML code of the web page be modified to deliver the help, as desired.

For a web page to operate in demonstration mode, a completely separate “dummy” site is commonly created with screen shots, inactive forms, and the like, to simulate the experience of navigating the site.

However, this simulation is typically not adequate because it often does not closely simulate the actual live site particularly if the site changes over time. The best method of training a user on operation of a web site is to use the actual live web site. However, this is not possible or desirable for security concerns and inexperience with a new user. Moreover, the demonstration site must be created and staged apart from the live site with the appropriate help and training assistance added thereto.

The requirement of completely re-writing the site and changed all of the relative page locations is burdensome, intrusive to the web site and expensive. Often, in the prior art, the code is written by experienced web designers requiring their involvement when any changes need to be made to the code that they have written. This code also frequently resides on secure server space making it difficult to gain access to the underlying files. This is problematic when other personnel, such as human resources, need to access the files for creation of a training site for its employees.

In addition to requiring the re-writing of the HTML code in page, prior art attempts to deliver interactivity to a web site suffer from the disadvantages of being web page or HTML code specific in its delivery of web-based help or demonstration capabilities. For example, each web page in the prior art has HTML code that is specifically written to add the features of demonstration mode or pop up help in the context of that web page. If the web page is written or moved within a web site, the HTML code for delivering that web help must similarly be modified to reflect the change in the structure of the web site. Thus, the HTML code for interactivity in a web site cannot survive across web pages in a web site.

In the prior art, there have been attempts to identify web based objects, such as a hyperlink or blank line in a web-based form, however, there is no method in the prior to uniquely and distinctively identify and differentiate one object from another. In the prior art, all web objects of a particular type or class are treated the same. This is a significant disadvantage makes the delivery of detailed and rich interactive help and training as well as operation of a web page in demonstration mode not possible with prior art methods.

There is a need for a method to deliver interactive help, assistance and training during the navigation of a web page and interaction with the web objects thereon. There is also a need for a user to navigate a web page in demonstration mode for training and other purposes. There is a further desire for a web site to operate in a controlled demonstration mode and/or to deliver interactive help and assistance without the need for modification of the underlying HTML code or the web objects contained therein. There is a further need to completely control the navigation of a web page by a user. Also, there is a need for interactive help and demonstration capabilities to be object specific to permit such help and demonstration capabilities to survive across any page within a web site.

Further, there is a particular need for an authoring component that is easy to use that can create a cross-platform file that can be run in any web browser to deliver customized interactive help to a user in accordance with the navigation of the web site and desired web object interaction by the user. There is also a particular need for an authoring component that can create a cross-platform file that can be run in any web browser to operate a web page in demonstration mode. There is a desire to provide a method of controlling the navigation of a web page that uses resources that are separate from the underlying HTML code to facilitate changes to the web help and demonstration capabilities to permit non-technical personnel to create and deliver such web help and demonstration capabilities without involvement of highly technical web designers.

### SUMMARY OF THE INVENTION

The present invention preserves the advantages of prior art methods for controlling the navigation of web pages. In addition, it provides new advantages not found in currently available methods and overcomes many disadvantages of such currently available methods.

The present invention solves these problems by overlaying a cross-platform “co-pilot” assist application to monitor a web page and to then change the page or pages of the site as desired and, thus, control the overall navigation of the site by the user. Such an assist application is preferred written in JavaScript but could be in any other cross-platform language that is readily parseable in a web browser.

In accordance with the present invention, typically, only two lines of code are added to the web page where a button can be provided to launch a single JavaScript file that is authored, as described below. The button is pressed to load the JavaScript file. As the user navigates a web page in a web site, the JavaScript application looks for web objects that have been defined earlier during the authoring process, according to the present invention. If a recognized object is, for example, clicked on or interacted with by the user, a java-based help box appears giving the user more information. Also, for example, if a user clicks on a blank line in a form, a pop-up box can appear for instructions. The JavaScript can also disable buttons, mask form input and control the user's ability to navigate.

This is particularly useful when instructing a user how to use a live web site, such as a hospital patient data intake site, in a training demonstration mode of operation.

Any mode of operation that lauches the JavaScript code is intended to be within the scope of the present invention. For example, it is also contemplated that another launch mode is possible where a customized browser (or player) itself contains the launching links and the JavaScript file resides on the users PC with nothing added to the pages. The JavaScript is injected into the page by that customized browser after the page is loaded in the users PC and the link within the browser is clicked.

Thus, the actual “live” web page within a web site can be overlaid with the JavaScript application of the present invention to completely control the navigation experience of the web page by the user. For example, the user can demo the actual site that they will use later in a real work setting without fear that the real web site will be operated incorrectly by the user. This demonstration of the live site is carried out without any intrusion into the HTML code of the site itself except for the simple reference to JavaScript file to be launched on the first page. The user can navigate from page to page within the site and receive customized context-sensitive pop-up help, and the like, that has been overlaid long after the HTML code has been written by web site personnel. Thus, a human resources department can add the instant JavaScript help layer, of the present invention, to the web site without impacting the underlying HTML code.

As will be described in detail below, the JavaScript control of interactive assistance and demonstration capabilities are created using the authoring component of the present invention. A web object or element (e.g., image or blank line in a form) on an existing web page is uniquely and distinctly identified and defined by the authoring component and an action is associated with that web object. The object is preferably uniquely identified by its HTML ID tag but can also be uniquely identified by one or more of the following characteristics of the web object: URL hyperlink, ALT text tag, existence of adjacent objects, location and size and combinations thereof. Such an action could be to pop-up a help box when the object is clicked. When all of the objects and the desired actions that are associated with them are identified, the JavaScript file is saved.

Upon launch of the JavaScript file after the web page to be controlled is displayed, the launched JavaScript searches for the earlier identified object as defined by the authoring component. When the object is acted upon as previously defined, no matter where the object is located within the entire web site, the JavaScript generates the appropriate interactivity, such as a help box, disabling of mouse clicks, and the like. Even if the page is changed but the object stays the same or even if the web object is moved to another page, the defined interactivity will still be generated regardless of where the object is located within the entire web site.

Thus, the present invention has the following unique features that make the method of the present invention superior to prior art methods. First, the defined web page interactivity survives across all pages within a site without any changes to the code on each page. Acting on an object (which was previously defined in the authoring component) on a web page causes an interactive action to occur regardless of where the object appears in the site. The method of the present invention can dynamically control a actual live web site without changing the underlying HTML code of the web site. The method can dynamically provide pop-up and sidebar help depending on what is present on the given page by identifying that a previously uniquely defined object is on the page. The authoring component of the present invention uniquely identifies and defines objects and elements for the generation of a desired interactive action.

The cross-platform JavaScript code can be launched by a button click in a standard browser by the user whereby the JavaScript file, located on the server where the web site files are located, is launched. A custom browser can also be used where the JavaScript file is automatically loaded from any location on the Internet if the web site has been altered using the tool of the present invention that can use the JavaScript described herein. In this latter case, the two lines of inserted JavaScript code need not even be inserted into the HTML code. However, this requires deployment of a custom browser. In the latter case in a custom browser, the user navigates to a given site that uses the present invention. The associated JavaScript file, for delivery of the custom overlaid content, can be automatically inserted rather than. requiring the two lines of JavaScript code to be added to the initiating page.

Therefore, it is an object of the present invention to provide a method of controlling a user's experience when navigating a web site by use of a JavaScript file that runs in the background to monitor user action to trigger interactive events rather than using specially written demo web sites or non-interactive instructional pop-ups. It is a further object of the present invention to provide dynamic interactive control that is object specific rather than page specific to ensure that the interactivity survives across web pages within a web site. It is a further object for a such a cross-platform application for controlling user navigation to be easy to use with little or no HTML coding knowledge.

### BRIEF DESCRIPTION OF THE DRAWINGS

The novel features that are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a pictorial representation of the Internet;

FIG. 2 is a block diagram of a client machine used to access the Internet;

FIG. 3 is a block diagram of a network used in accordance with the present invention;

FIG. 4 is an illustration of a web page with a button for manually launching the assist program of the present invention;

FIG. 5 is an illustration of a web page that is running the assist program of the present invention;

FIG. 6 is an illustration of a web page that is running the assist program of the present invention with a dialog box being displayed;

FIG. 7 is an illustration of a web page that is running the assist program of the present invention showing the highlight tool in use;

FIG. 8 is a flow chart showing use of the method of the present invention to control navigation of a web page by a user;

FIG. 9 is a flow chart showing use of the authoring component of the present invention;

FIG. 10 is an illustration of the authoring component of the present invention;

FIG. 11 is an illustration of the authoring component linking a web object to the highlight tool;

FIG. 12 is an illustration of the Pick settings for the highlight tool;

FIG. 13 is an illustration of the Highlight Settings for the Highlight Tool;

FIG. 14 is an illustration of the authoring component linking a web object to the Click Tool;

FIG. 15 is an illustration of the Pick Settings for the Click Tool;

FIG. 16 is an illustration of the Click Settings for the Click Tool; and

FIG. 17 is an illustration of the Content Pop Up preferences for a show.

### DETAILED DESCRIPTION OF THE PREFERRED EMBODIMENT

The method of controlling the navigation of web pages or an application accessed through an HTML-based graphical user interface (GUI) in accordance with the present invention is typically used in connection with web pages viewed on a machine connected to the Internet. However, any computer, even a standalone computer, that uses a web browser to view web pages or any application accessed through an HTML-based graphical user interface, can employ the method of the present invention. Since the most common environment for viewing web pages will be via the Internet, for ease of illustration and discussion, the present invention will be described in detail in connection with such environment. However, it should be understood that the scope of the present invention shall not be limited to use on the Internet for web pages.

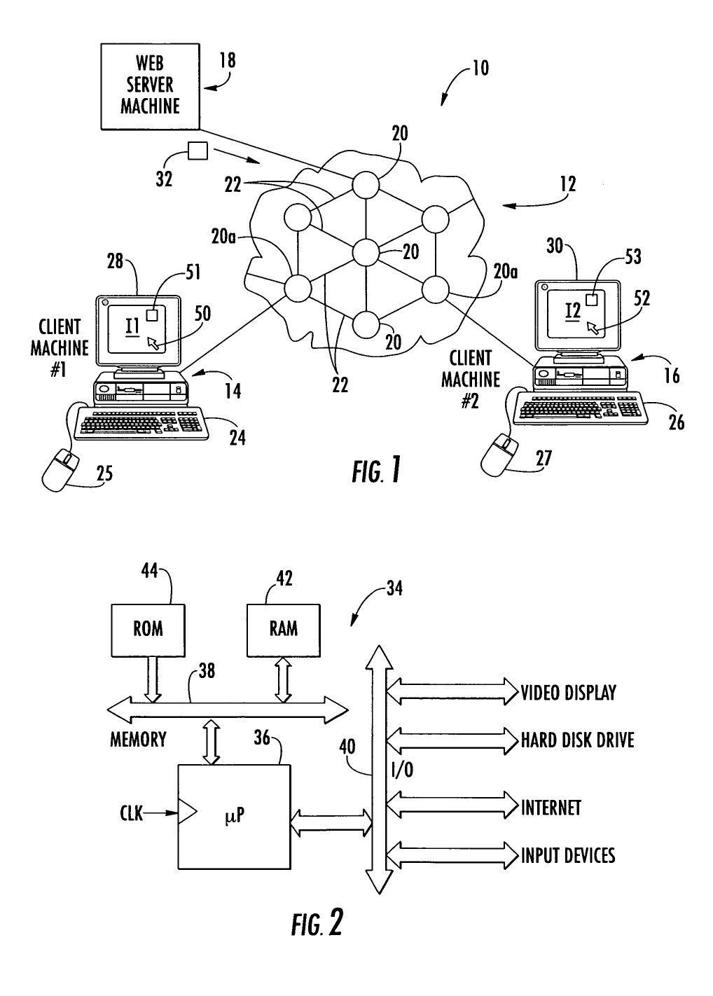

Referring first to FIG. 1, a diagrammatic view of a network system 10 includes a wide area network (WAN), such as the Internet 12. A number of computers or “machines” are coupled to the Internet 12. For example, a first client machine 14, a second client machine 16, and a web server machine 18, are coupled to the Internet 12.

As stated above, both the Internet 12 and Intranets operate using the same TCP/IP protocols. This allows Intranets to use similar or the same server machine software and client machine software as are used in Internet 12 applications. The Internet 12 includes a number of nodes 20 that are interconnected by data transmission media 22. These nodes are typically routers, switches, and other intelligent data transmission apparatus that route “packets” of TCP/IP information to the desired destination. In some instances, the nodes 20 comprise an Internet service provider (ISP) 20a that allows a client machine to access the “backbone” of the Internet. Alternatively, client machines 14, 16 and web servers 18 can be coupled directly into the backbone of the Internet 12. The connectivity of the Internet 12 and networks are so well known in the art that they need not be discussed in further detail.

As noted previously, the present invention is directed to a method for controlling the navigation of web pages, such as over a network including the Internet 12. To enable the user to interface with the client machine, input devices 24, 25 and 26, 27 can be provided as part of the client machines 14 and 16, respectively. Typical input devices are keyboards 24, 26 and mice 25, 27. Other input devices, such as hand held remote controls (not shown), can also be used. The client machines 14 and 16 are typically provided with computer video monitors 28 and 30 (which is one example of a “visual display”), respectively, which can display images 11 and 12, respectively. As is well known in the art, computer keyboards 24, 26 and mice 25, 27 are employed to control the overall operation of the computer and serve as the interface between the user and the machine 14, 16. In particular, a keyboard 24, 26 is commonly used to input text and navigate by keyboard “shortcuts”. Mice 25, 27 are commonly used for the control of a cursor 50, 52 on the monitors 28 and 30, respectively, for the selection and manipulation of computer objects 51, 53, such as web objects on an HTML web page.

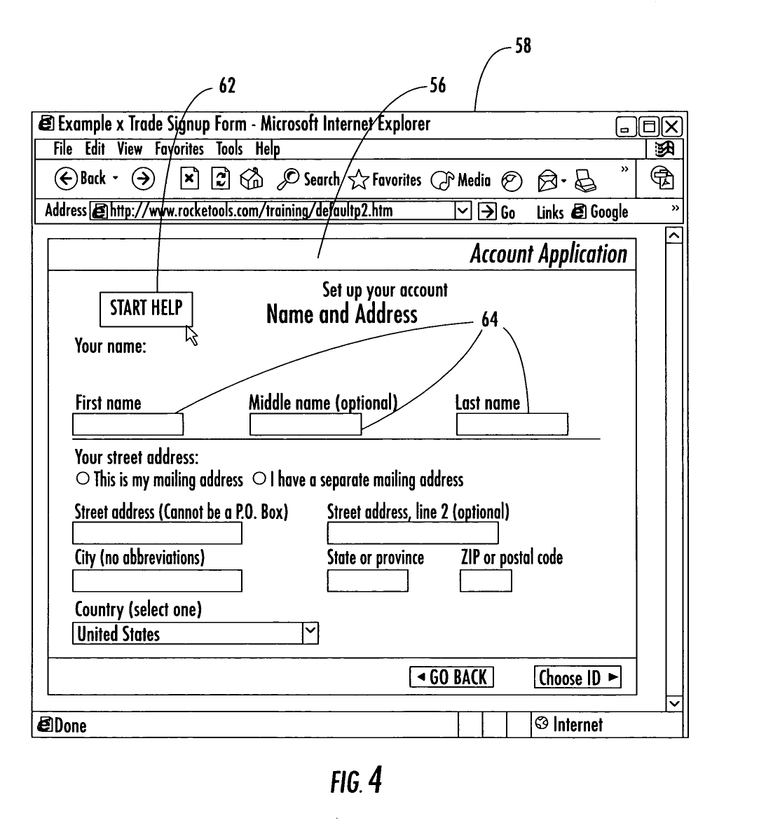

FIG. 3 shows a block diagram of the general configuration of a client machine 14, 16 connected to a server 18 so that the client machine 14, 16 can receive and display web pages for later navigation by a user. Input devices, 24, 25 interface with the client machine 14 via input devices 24 and 25. The use and operation of keyboards and mice are so well known in the art, they need not be discussed in further detail.

The machines 14, 16 and 18 are considered, in the language of the Internet, to be “resources,” and each has its own unique Uniform Resource Locator (URL). In one embodiment of the present invention, a client machine, such as client machine 14 or 16, sends a request for a “web page” residing on, for example, web server machine 18. This is accomplished by the client machine sending a connection request and a URL that specifies the address of the web page to the web server machine 18. The web server machine 18 then sends a web page 32 in HTML format back to the requesting client machine 14, 16 where it is “cached” in the memory (typically the RAM, hard disk, or a combination of the two) of the client machine 14, 16. In this embodiment of the invention, the image on the video display of the client machine 14, 16 is generated from the HTML web page file cached on the client machine 14, 16.

Upon display of the HTML page on a client machine 14 or 16, it is in condition for navigation by a user. The method of the present invention, in general, “control” the navigation of with HTML web page by the user. This “control” is understood to be any type of action not made by the user that affects his navigation of a web page. For example, as will be described in detail below in connection with the method of the present invention, this control can come in the form of a content help box, disabling of web objects on the web page, placing the web page in demonstration mode or any other similar interface with the user.

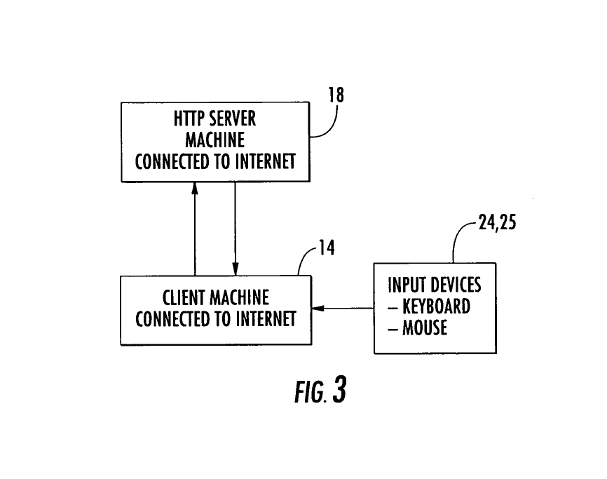

Referring back to FIG. 2, a general overview of the components of the architecture of a computer is shown. The architecture of a computer 34 can be used for client machine 14 or client machine 16 is shown in block diagram form. It should be noted that a variety of machine architectures can be used to access the Internet 12, such as a PC compatible computer under the Windows or MS-DOS operating system, Macintosh personal computer, SUN or Silicon Graphics workstation, home video game systems (such as systems available from Nintendo, Sega, or Sony), “set top box”, “network access computers”, portable/handheld computers of all types, or any general-purpose computer. The particular architecture shown for the computer 34 is a typical personal or “PC” computer architecture. Web server machines 18 can also have similar architectures, but are often more powerful “workstations” that, for example, operate under some variant of the UNIX®. operating system. The Internet service providers 20a are likewise often UNIX-based computers or powerful personal computers running Windows NT®. The nodes 20 are most commonly routers built by Cisco Systems of San Jose, Calif. Client machine 14 or 16 can also take other forms, such as a television including or connected to a microprocessor for Internet access.

The personal computer system 34 includes a microprocessor 36 clocked by a system clock CLK and that is coupled to a high speed or memory bus 38 and to a lower speed or I/O bus 40. The system RAM 42 and ROM 44 are typically coupled to the high speed memory bus, while various peripherals, such as the video display, hard disk drive, Internet interface (often either a modem or an Ethernet connection) are typically coupled to the slower I/O bus. The microprocessor executes programs stored in the various memories or other computer-readable medium of the computer 34 (RAM, ROM, hard disk, signal propagated by a carrier wave, etc.) to control, for example, the image display on the video display and the input devices 24, 25, 26 and 27. The manufacture and use of computers, such as personal computer 34, are well known to those skilled in the art.

The present invention includes a method of controlling the navigation of web pages by a user as well as an authoring component to set up and deliver the parameters for the aforesaid method for controlling the navigation of web pages. The method of controlling the navigation of web pages by a user will first be discussed in detail to illustrate the invention in actual practice and use. Then, the authoring component will be described in detail to illustrate the method of setting up and programming the execution of web page navigation control that is desired.

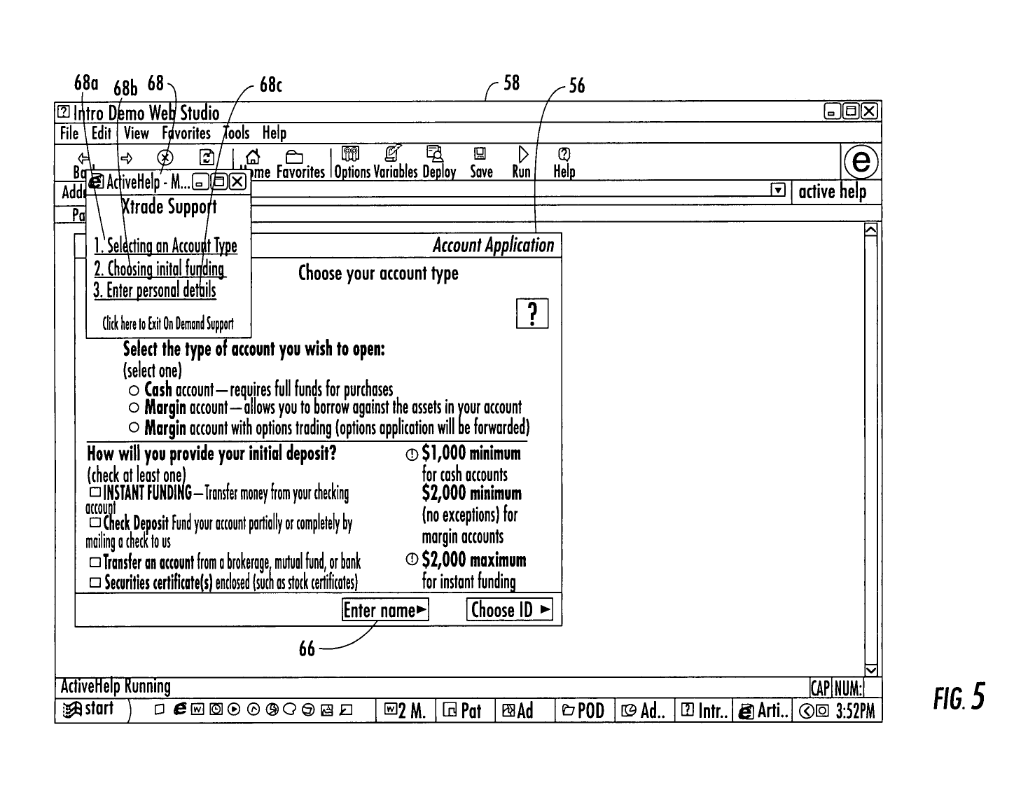

Referring to FIG. 4, a flow chart of navigation of a web page 56, in accordance with the present invention, is shown. For ease of illustration, the present invention will be discussed in connection with Client Machine No. 1 shown in FIG. 1, referenced to as 14. First, a web page 56 must be displayed on the monitor 28 of the client machine 28. Since it is assumed that this page 56 is delivered over the Internet 12, a connection must first be established between the client machine 28 and the server 18. A web browser 58 on the client machine 28 is launched and an initial start page is loaded into the browser 58.

Next, the assist program of the present invention is launched. As will be described in detail below in connection with the authoring component 60 of the present invention, the assist program is preferably JavaScript but could be in another program language as well, such as a cross-platform language. Since the JavaScript language and method of launching a program written in such language, such as in a web page 56 is well known in the art, a discussed herein is not required. A person of ordinary skill in the art would understand the writing and use of this language and other similar languages.

The assist program can be launched in a variety of ways. The method that is used depends on the situation at hand and where the JavaScript assist program is physically located. For example, the JavaScript file may be located on server 18 that is accessible to the Internet 12 or it may reside on a local network or even on the client machine 14. Each method is described below. The third method is the most self-sufficient option. First, the assist application can be launched from the web page 56 itself. For example, as shown in FIG. 4, a link, in the form of a button 62, can be provided on the web page 56 that is going to receive navigation control to be later manually selected and clicked by the user. In the example of FIG. 4, the web page 56 has a number of fill-in form blanks 64 that the assist program can help the user navigate.

Launching the assist program manually requires that the web page 56 has two things:

1. A statement between the page's <Head> tags that tells the browser about the JavaScript file to be used by the assist program, also known as ActiveHelp, which is trademark of Rocket Software, Inc., the assignee of this application. For example, the following statement may be used if JavaScript is the language selected for the assist program:

<script language=“javascript” src=“myfilename.js”>

2. A visible hyperlink on the page that the user can click to launch the show. This could be in the form of button 62.

This method requires that you have these two elements in one page of the application. Once the assist program is launched, it will run continuously as the user moves from page to page without requiring any more links or statements.

Also, the assist application can be launched when the web page 56 is loaded. This method is similar to launching the assist program show from an application page except that it does not require a hyperlink in an application page. This method does require two changes to at least one page:

1. A one-line statement between the page's <Head> tags that tells the browser 58 about the assist program (ActiveHelp) JavaScript file.

For example, the following statement may be used:

<script language=“javascript” src=“myfilename.js”>

2. An onLoad statement included in the body tag of the application's first page to start the show. For example, the following statement may be used:

<BODY onload=go_myfilename>

Still further, the assist program may be launched from another web page. While both of the other methods are relatively uncomplicated, the developers of the training and performance support typically do not have direct access to the directories holding the application or web site. The custodians of the application are reluctant to have others modify their pages or even have access to them except through a secure area. These limitations require a remote launch solution that honors this separation of responsibilities. This method does not require modifications to the application page 56 or its directories. A few lines of required instruction are placed on a separate launching.

It should be understood that the foregoing methods above for launching the assist program of the present are specified for JavaScript. However, a person or ordinary skill in the would understand how to similarly launch an assist program in a language other than JavaScript. An assist program in any language is considered within the scope of the present invention.

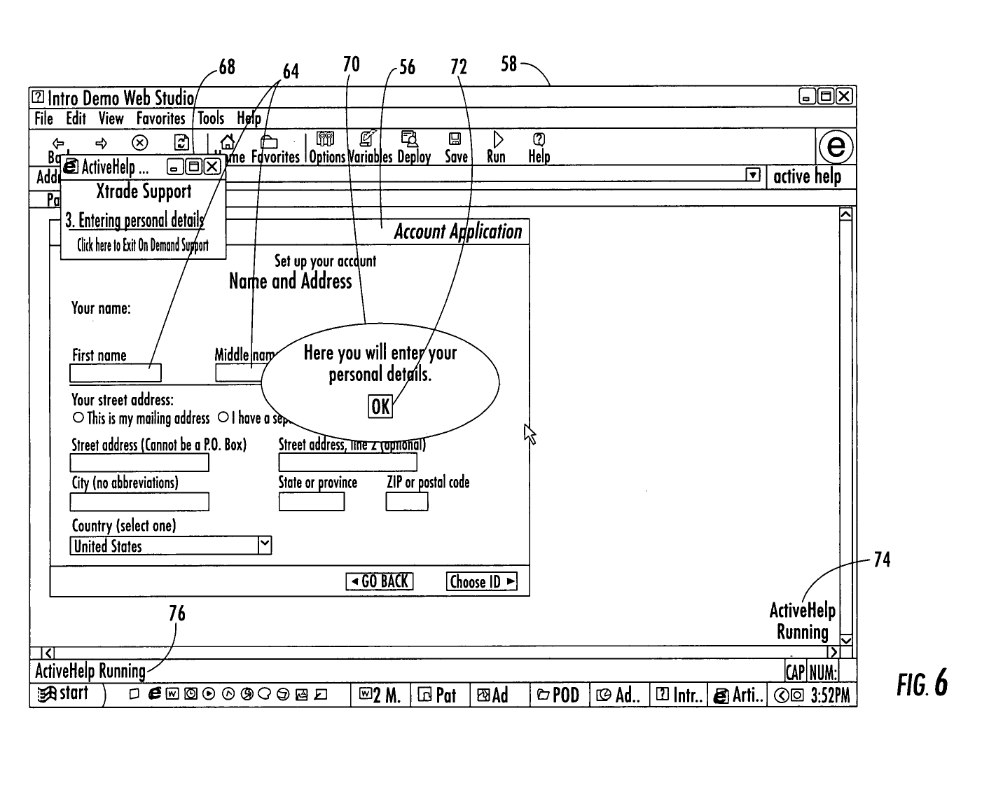

Referring now to FIGS. 5-8, details of the implementation of the assist program with an actual web page 56 is shown and described. To illustrate the use of the method of controlling a web page 56 in accordance with the present invention, an example web page 56 is shown and described. In this example, a securities account application is shown. Without using the assistance and web page control of the present invention, a user navigates a web page 56 containing a web fill-in form with blanks 64 similar to that shown in FIG. 4. First, the user must enter their personal details before choosing a login ID. They click on the button 66 “Enter Name” at the bottom of the screen to hyperlink to another web page 56 containing form for entry of such data. However, it may be unclear to the user which button 66 to click or how to enter the information once they reach the personal details page 56.

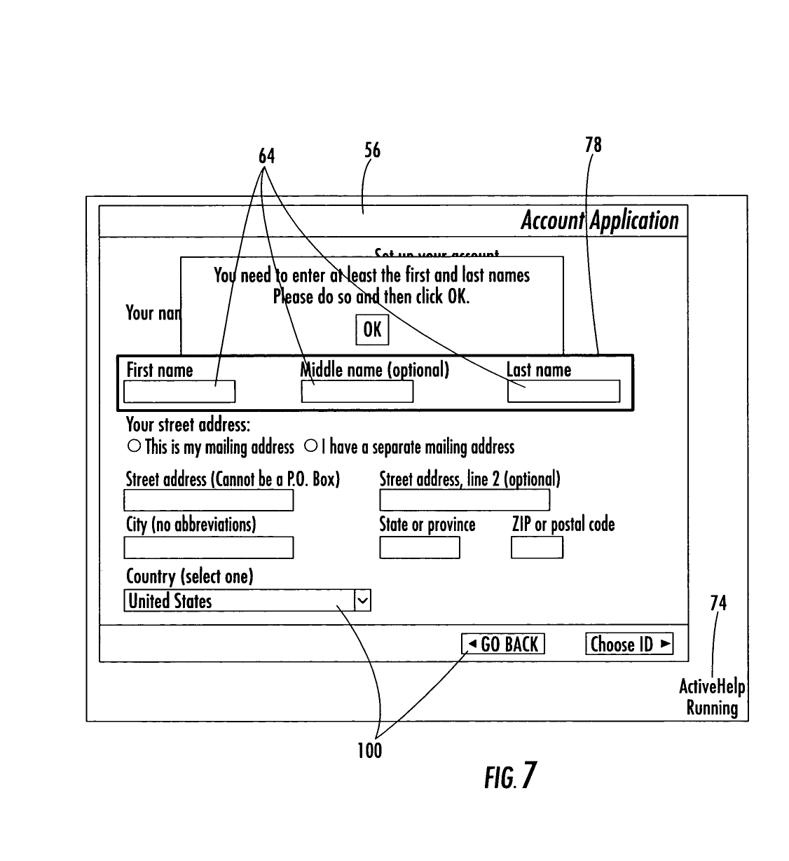

The method of present invention, in this example, serves as a “co-pilot” type software to guide the user through the necessary steps for filling in the blanks 64 of the desired form. The assist or ActiveHelp program file is first launched by one of the methods described above. In this example, a content pop up window 68 appears in the upper left hand corner of the screen. This pop up is preferably generated in a separate browser instance. The content pop up 68 gives the user a number of options, such as “1. Selecting an Account Type”; “2. Choosing Initial Funding” and “3. Enter Personal Details”. Each of these selections are linked to another item or web page. In this case, the third item links to another web page, namely, the personal details screen web page 56, shown in FIG. 6. Thus, the method of the present invention will deliver assistance on-the-fly to the user to help them fill in the blanks 64 this form.

Upon clicking on the link entitled “3. Enter Personal Details”, the user is directed to web page 56 shown in FIG. 6. The content pop up box 68 dynamically changes to reflect the fact that the user is on this page 56. Also, a dialog box 70 appears that informs the user that they are about to enter their personal details. This dialog box 70 is dismissed by simply clicking the button 72 labeled “OK”. The active running of the assist program can be confirmed by viewing a status message 74 in the lower right hand corner of the screen as well as in the status bar of the web browser 56 at the location referenced 76.

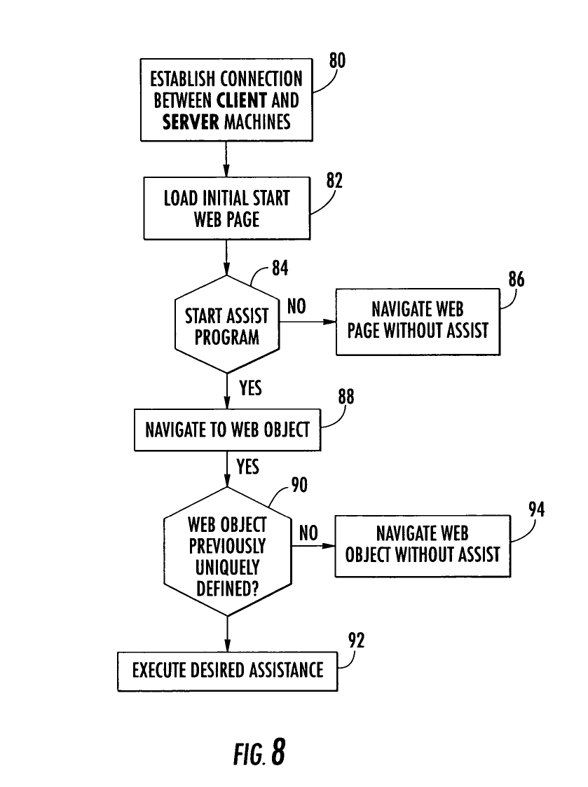

After the dialog box is dismissed, the assist program of the present invention, as previously programmed, highlights the fill-in boxes 64 with a highlight box 78 for the user's first name, middle name and last name, as seen in FIG. 7. At this point, the user simply enters their personal information as guided by the assist program. Thus, the user is guided step by step or as desired according to what has been programmed into the assist program for what is appropriate for the given web page 56 at hand.

As will be discussed in detail below, the authoring component 60 of the present invention can design virtually any type of guidance to assist the user during their navigation of that web page 56. In the example of FIGS. 5-7, the assist program guides the user to fill in the blanks 64 of the online form. It is also possible to prevent the user from entering any data into the form so that the web page 56 is viewed in a demonstration mode only. In that connection, clickable links, buttons and blanks, generally referred to as web objects 100, can be disabled or controlled by the assist program to act and react as desired, which is not necessarily how these objects 100 would act and react as originally intended during the creation of the web site. Thus, in general, the user's navigation experience of a web page 56 is controlled, either partially or fully, by the overlaid assist program of the present invention.

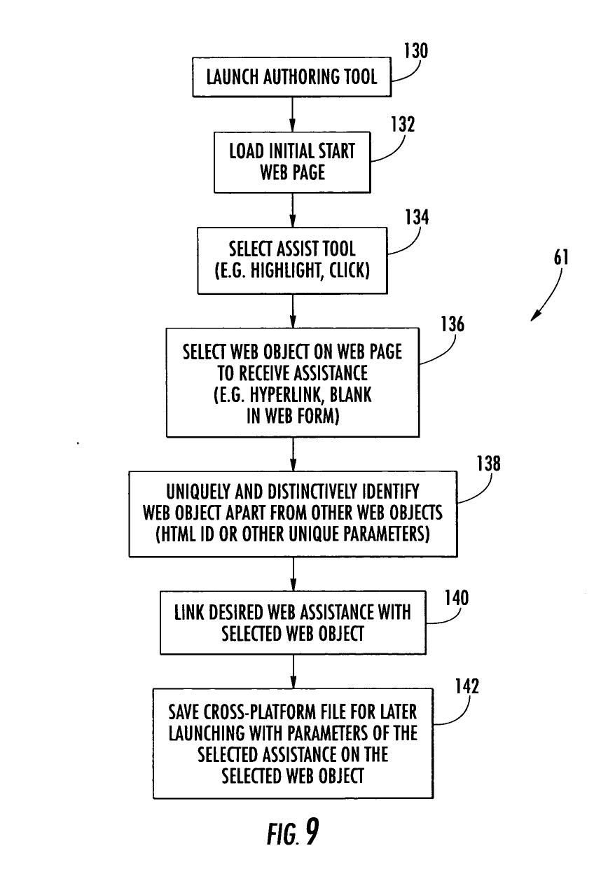

FIG. 8 illustrates the interaction of assist program when viewing a web page 56. First, a connection is made between the client machine 14 and server machine 18 at 80. Then, a web page 56 is loaded at 82. If the assist program is not loaded at 84, then no assistance will be provided and the web page 56 will perform as originally intended at 84. The start of the assist program will begin monitoring of all navigation activities of the user. If the user then navigates to a web object 100 or to a page 56 at 88. If that web object 100 has been previously programmed at 90 in the assist program to act differently than originally intended, the desired assistance will be delivered and then executed at 92. If the web object 100 navigated to does not call for web assistance, then the assist program will do nothing as seen at 94.

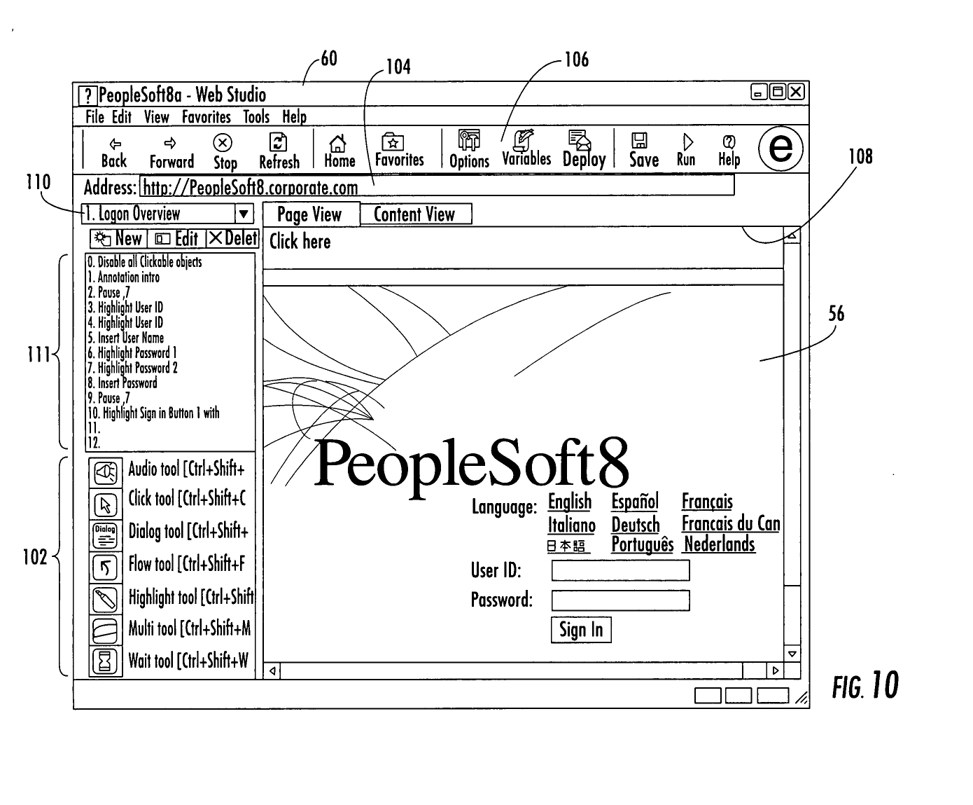

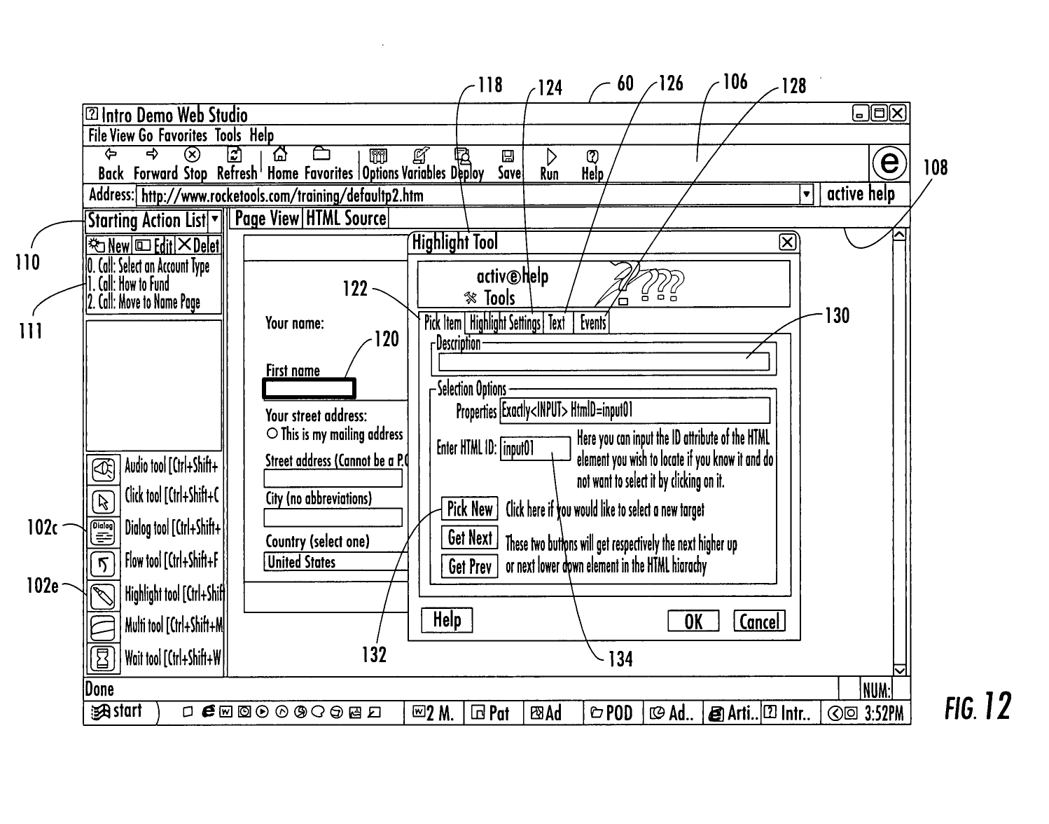

The delivery and execution of navigation control is pre-programmed into the assist program, namely the JavaScript file, so the manner and content of the control of the web page 56, be it in the form of help or demonstration mode, and the like, performs as desired. To facilitate the programming and creation of the JavaScript file to server as the assist program, an authoring component 60 is also provided as part of the present invention. This tool is shown and described in connection with FIGS. 9-17 below.

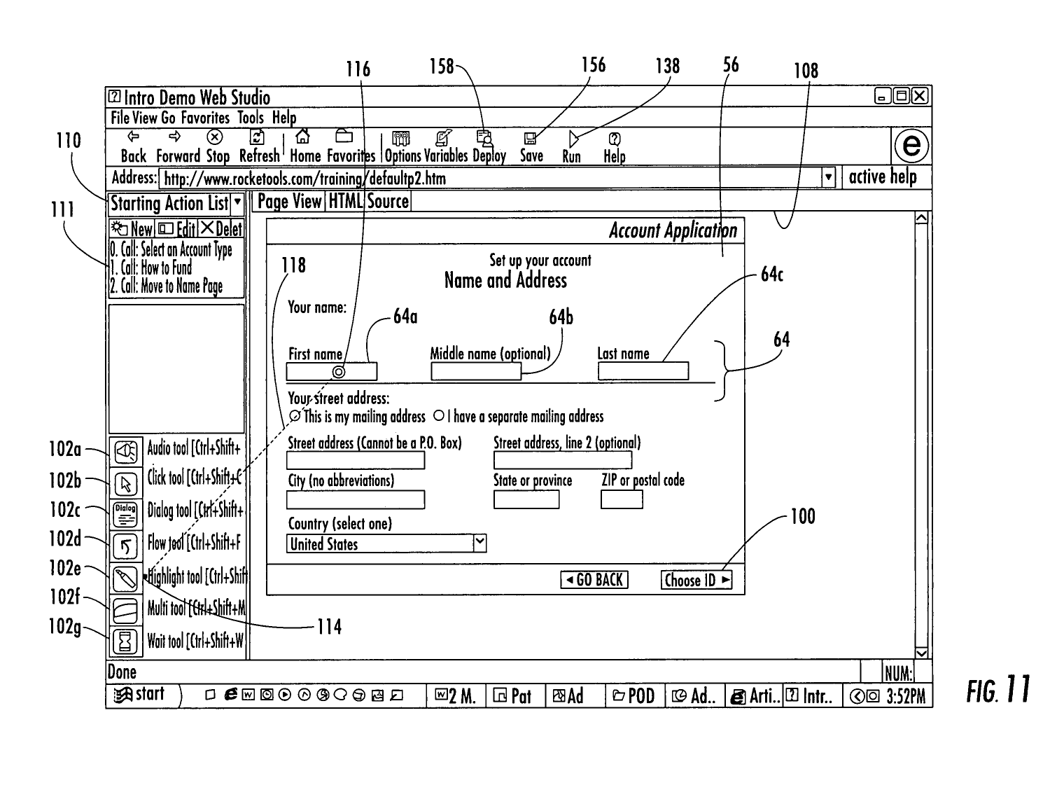

Referring to FIG. 9, a general overview of the authoring component 60 of the present invention, in the form of a flow chart 61, is shown. Referring to both FIGS. 9 and 10, the authoring component 60 is first started. By way of example, the authoring component is an application that is shown written in a language suitable for use on a computer running a Windows-based operating system. It should be understood that the authoring component can be ported or written for use in any type of operating system, such as Unix.

The authoring component 60 is a development tool that allows the creation of on-the-fly assistance or use of a web page 56 in demonstration mode. The JavaScript file that is created is very lightweight and will run in a web browser 58, such as Internet Explorer, Netscape, Mozilla, and the like, and on any operating system without a player, download or plug-in. The authoring component 60 is launched at 130 in FIG. 9.

The content, such as pop-up boxes 68 and dialog boxes 70, works with web sites and with applications accessed through a web browser 58.

The authoring component 60 is used to create the “shows” that can run in the user's web browser 58. The authoring component 60 includes a number of dynamic, smart tools 102 that allow duplication of most actions a user would make during the course of navigation of a web page 56.

This enables the method of controlling the navigation of the web page 56 by the user to be carried out in accordance with the present invention.

The authoring component 60 is a real time “what you see is what you get” (WYSIWYG) application that automatically generates JavaScript through direct interaction with the application or HTML page. As a result, it is capable of running across and interacting with a sequence of independent HTML pages. This unique characteristic allows a single content file to accompany the user or learner through a multi-step and multi-page process.

The authoring component 60 is generally in the form of a browser-like interface with a URL address window 104 and tool bar 106. A target application pane 108 is included for displaying a web page 56 to be controlled as well as a list of studio tools 102 and a list of actions 1 10.

A show created by the authoring component 60 consists of a Starting Action List 110 that uses Flow Tools 102d to call subordinate Action Lists 110 in sequence at runtime. Each subordinate Action List 110 focuses on a discrete step in the show and contains a series of Actions 111 that are created by the Tools 102 that are run in sequence to perform this step.

Shows are composed of a series of sequential steps, Actions 111, grouped into a series of Action Lists 110. Action Lists 110 are combined with the Flow Tool 102d to create a Show. The tools 102 are used to generate each of the Actions 111 (steps) within the show. Shows can contain as many Action Lists 110 as desired. When building a show that performs more than one or two basic steps, the best practice is to create a main Starting Action List 110 from which all of the Action Lists 110 will be called with the Flow Tool 102d and then flow will return to the Starting Action List 110 before flowing to the next Action List 110, such as an Action List called “Logon Overview”, as seen in FIG. 10. This structure makes it easy to test individual Actions Lists 110 without running the entire show and to edit, change and manage the Show. Each of these individual Action Lists 110 should focus on a single discrete step in the show. The Flow Tool 102d controls the movement the show from Action to Action 111. Such flow can be set using method of looping and skipping, “if . . . then” structures and input masks.

Context-Sensitive Online Help is available in every pop-up tool window (launched when a target or web object 100 is clicked) and on each tab of those windows. First, the page 56 for which help is going to be authored or the page that is going to be modified on-the-fly to run in demonstration mode is first loaded into the authoring component at 132.

This can be done by opening the page 56 off of the File menu in the authoring component 60, entering the URL address of the page or selecting the page from the Favorites list.

Once the web page 56 is loaded into the authoring component, a number of the smart tools 102 are then used at 134 to design the type and nature of control of the user's navigation and overall interaction with the web page 56. Each of these preferred tools 102a-g will be discussed in detail below.

The highlight tool 102e is employed to mark a web object 100 to later call attention to it, such as ringing a button or list box item before performing an operation on it. This tool 102e can include multiple highlighting shapes, colors and styles, with optional accompanying text balloons to bring close attention to the object. This tool 102e is also used to exchange data with the application page 56 by copying to or pasting from variables. A built-in HTML editor allows text to be entered and display in HTML format with bold, italics, color and the like.

The dialog tool 102c is used to ask the user a question or present him with information. If offering choices, performs actions based on the user's selection. It can also be used to capture user input. A built-in HTML editor allows text to be entered and display in HTML format with bold, italics, color and the like.

The audio tool 102a is used to record audio, such as voice-overs for later use as part of the control of the navigation experience by the user.

The flow tool 102d performs programmatic flow operations such as calling or jumping. It can also test and compare variables and direct flow based on “if . . . Then” statements, for example.

The multi-tool 102f executes hyperlinks and enables the show to bridge across pages or screens at runtime. HTML Hyperlinks can be created to link to a new page by using HTML hyperlink syntax. When pages are linked with this tool a single JavaScript will continue to run across the linked pages. The multi-tool 102f includes a scripting option allows the insertion of valid JavaScript statements that are executed as an action in the Action List 111. This can include JavaScript to launch a new page 56. Also, the multi-tool 102f includes a page interaction control to provide complete control over the user's interaction with the application page (or frame).

The JavaScript tool is part of the multi-tool 102f. This tool is used to enter Java Script code as Actions in the Action List, which will be described below. This tool allows the seamless mix of custom code with code generated by the tools of the present invention. Thus, custom JavaScript code can easily be added.

The wait tool 102g introduces a time delay or tests and waits for a change in the status of a form element, such as a text box, drop-down list, radio button or check box.

The click tool 102b allows the monitoring, management, prohibition, and execution of clicks on the application page 56. This tool 102b is particularly useful for running a web page in demonstration mode where it is desired that clicking on certain web objects 100 should be prohibited.

As described in detail below, the click tool 102b can also change the function of or “re-purpose” a clickable object. For example, the click tool can re-purpose a clickable object to launch a simulation or display a message.

Further the click control tool, which is part of the multi-tool 102f, restricts all user mouse and keyboard interaction with the application page 56.

The variables tool, accessible under the Tools menu item in the authoring component application, allows the creation and setting the initial values of variables as well as management all the variables. Variables can also be set on the Events tab, as will be described below, within the following tools: highlight 102e, dialog 102c, multi 102f, wait 102g, and audio 102a.

More specifically, a variable is an item of information that is given a name and stored for later use. The ability to create and evaluate variables gives the author enormous flexibility and power in the creation of shows that can respond to specific conditions and user behaviors.

Variables can be created in a variety of ways. For example, they can be created directly with the Variables Tool, with event handling, with the Highlight Tool 102e or with JavaScript within the Multi Tool 102f. Variables can even be created on-the-fly by capturing text with the Highlight Tool 102e. The variables can then be used to create dialogs or customize help being provided, for example.

It should be understood that the foregoing tools 102a-g described are the preferred software tools for creating a JavaScript file in accordance with the present invention to control the navigation of a web page by a user. There may be other tools for such purposes that can be employed in the authoring component. Any tool used that can control the navigation of a web page 56 by a user is considered to be within the scope of the present invention.

First, the flow of assistance or demonstration must be determined.

The task to be completed must first be identified so that the authoring component 60 can be appropriately used to deliver the desired result. As stated above, any aspect of the navigation of a web page 56, within a web site, by a user can be controlled using the method of the present invention.

For ease of illustration, the creation of a JavaScript file, in accordance with the present invention, to deliver assistance to filling in the blanks 64 of the web fill-in form shown in FIGS. 6 and 7, will be discussed in detail. A securities account application is shown. There is a desire to assist the user in filling in the blanks 64 of the form. In this simple example, the first name 64a of the user must be filled in. It is desirable to draw the user's attention to the fill-in box 64a entitled “First Name”. Thus, for example, it is useful to employ the highlight tool 102e for this purpose.

To use the Highlight Tool 102e, which is located in the Tool Box 102 at the bottom of the Action List 111 pane to select it, it is clicked once. A dot 114, which can be red in color, for easy identification, appears next to the tool 102e to indicate that it is active. The cursor 116 is moved to the application window with a wire 118 connecting the tool 102e to the cursor 116. The cursor 116 is then moved to the intended target location, such as a graphic, text box, and the like, in the Application pane 108 at the right and then is clicked once. In this example, the text box 64a, labeled “First Name”, is selected for being acted upon by the Highlight Tool 102e.

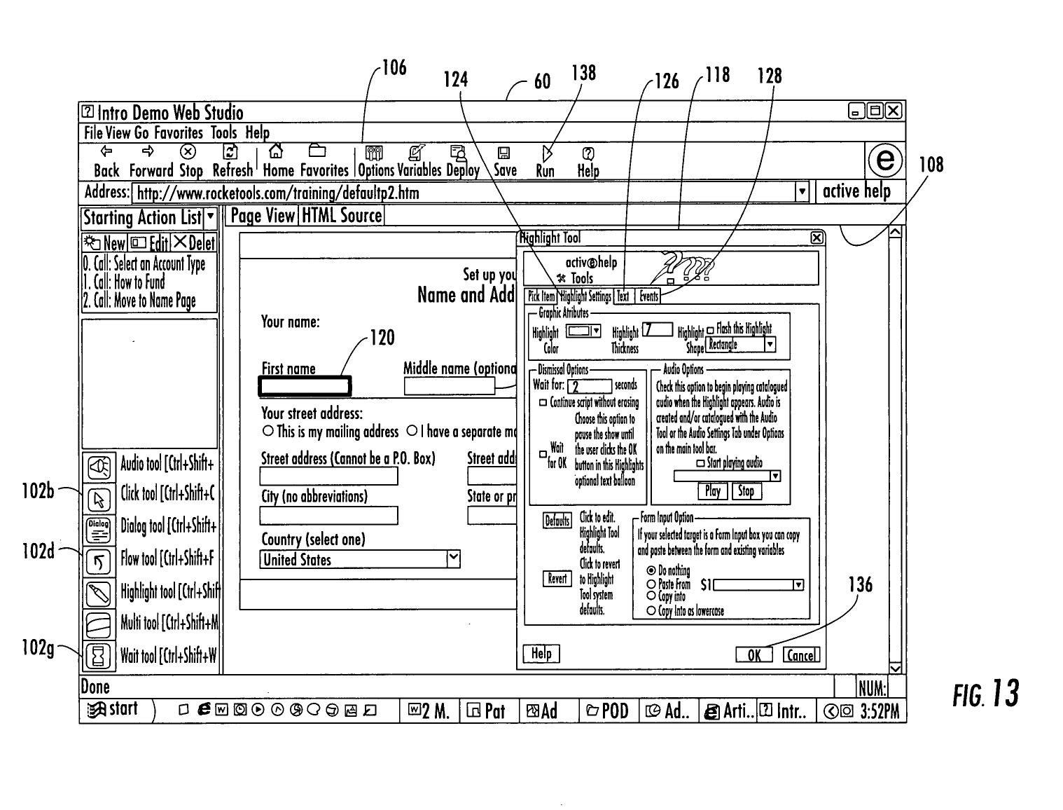

The authoring component 60 analyzes the target, i.e. text box 64a in this case, and identifies its unique attributes. As shown in FIG. 12, a settings window 118 for the highlight Tool 102e opens in the Application pane 108 and a highlight 120 appears around the identified target, namely text box 64a. The Highlight Tool 102e settings box 118 has four tabs: Pick (for re-picking targets) 122, Highlight Settings 124, Text 126 (for the optional text balloon), and Events 128. In the Description box 130, an Action name is assigned that will be meaningful when it appears in the Action List 111. The “Pick New” button 132 permits a new target to be picked.

All of the tools 120a-g offer an Events Page 128. These setting determine what will happen after the present Action is finished based upon its results or upon user choices. For example, the Dialog Tool 102c lets multiple-choice answers to be offered to the user. The Events Page 128 lists all of the possible outcomes of each particular tool 102a-g, including possible errors. Each of these outcomes is called an Event. The Events are listed with the tool-specific ones first, followed by the Standard Events that are used throughout the authoring component.

In FIG. 12, it is possible to directly enter the unique HTML ID for the selected object at box 134 to ensure that the programmed assistance will follow the object no matter where it appears on the web page 56 or on the entire web site. The object 100, such as box 120, is preferably uniquely identified by its HTML ID tag but can also be uniquely identified by one or more of the following characteristics of the web object 100: URL hyperlink, ALT text tag, existence of adjacent objects, location and size or a combination thereof. Where no ID tag is available in the HTML code, the authoring component 60 will automatically detect this and then use its own unique procedure to get a unique identity for the target object. It will do this by identifying what the target is (graphic, table cell, etc.), what page it is on, where it is the page structure, what is adjacent to it, etc. This enables the assist program to identify the correct target at runtime, even if that target has been moved by a change in browser configuration, changes in the page or because the page is generated ‘on the fly.’

In the absence of HTML IDs, the assist program employs a matching algorithm appropriate to the nature of the element and the information stored about it during the authoring phase. For example, if the action requires the identification of a given button and the page contains 12 such buttons, a matching algorithm will be employed to narrow the 12 candidates to the one that is deemed to match the intended target. If, for example, the target button element at ‘author time’ contained a hyperlink URL, the URL of each of the 12 candidates at ‘runtime’ is compared against the original. It is important to note that the runtime URL does not need to match the original; the assist program is capable of ‘fuzzy’ matching the URL to the best candidate. In a similar fashion, other element-specific aspects are examined and analyzed, such as the element attributes, image locations, tags and event handlers before selecting the candidate that most closely matches the target. It must be noted that the assistive program employs a ‘confidence threshold’ such that it does not errantly select an element when the target element is no longer included in the web page. Any type of matching algorithm for this purpose can be employed and still be within the scope of the present invention.

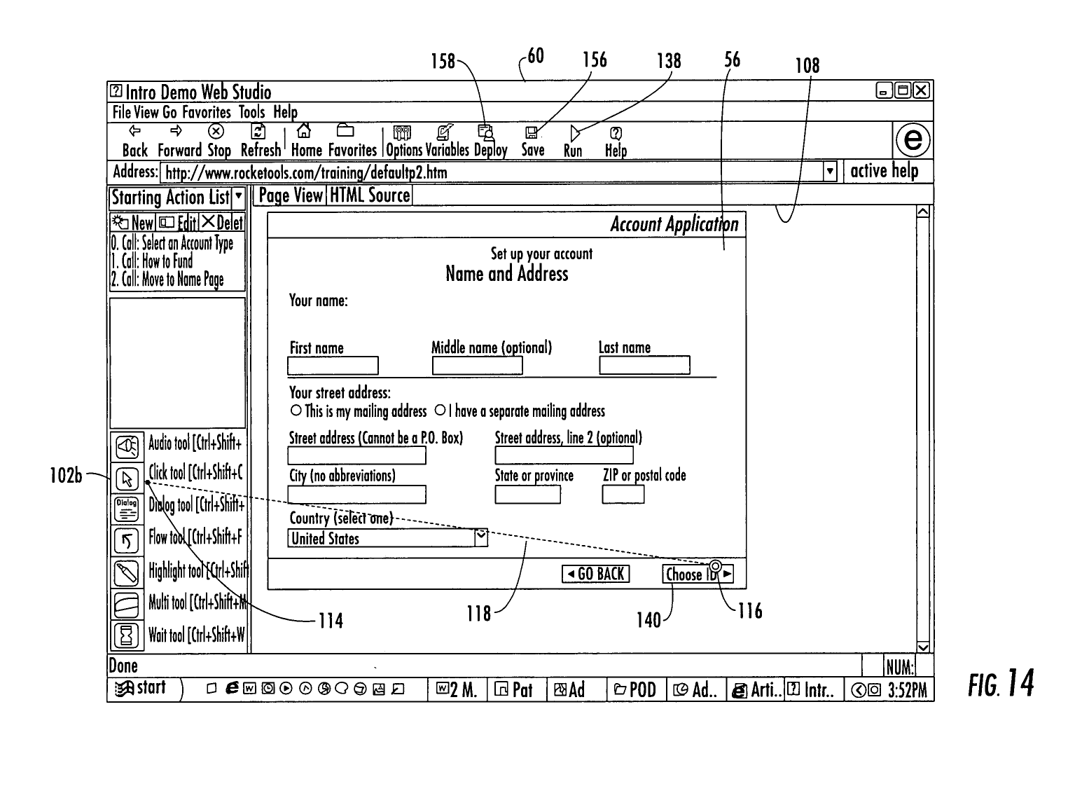

As seen in FIG. 13, the Highlight Settings tab 124 in the Highlight Tool settings window 118, which is the second tab, includes options for Highlight thickness and color to improve the aesthetic appearance of the highlight. The text tab 126 allows for the creation of a balloon to accompany the highlight. The Events tab 128 is used to determine what will happen after the highlight is displayed, as discussed above.

When the overall appearance and profile of the Highlight Action to the First Name text box 120, clicking OK button 136 saves it to the Action List 111. Clicking on the Run button 138 in the toolbar 106 above the Application pane 108 tests the Highlight action item that was just created.

The authoring component 60 can employ an input mask that can be very useful in connection with the entry of text in a form. An input mask is a pattern against which the user's input is compared to ensure that it meets basic format requirements. It defines the format of the content but not its exact composition. Input masks are available in the settings windows for the Flow Tool 102d and in the Wait Tool 102g. In the Flow Tool 102d, the contents of a text box or existing variable can be tested against a mask. In the Wait Tool 102g, the flow can be paused until the contents of a text box on the application page 56 matches a defined mask. When the match is made a “true” event can occur.

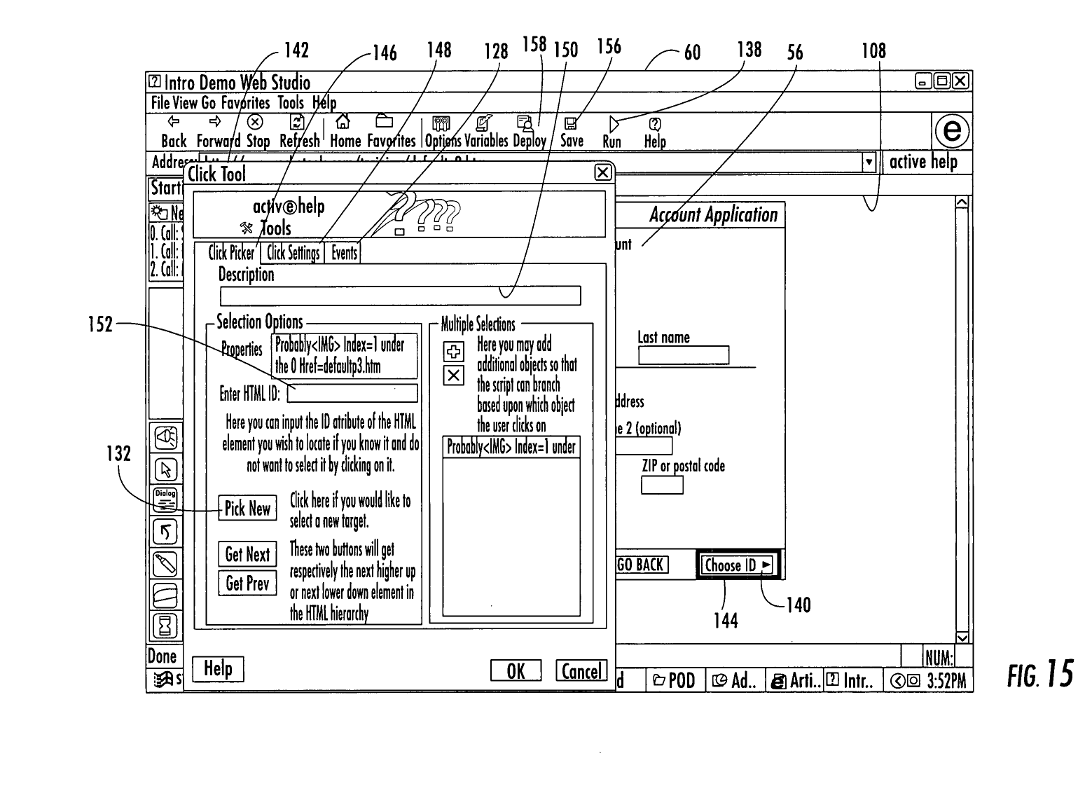

As a further example of the authoring component 60 of the present invention, the use of the Click tool 102b is shown in connection with FIGS. 14-16 to control the clicking of a web object 100. To use the Click Tool 102b, located in the Tool Box 102 at the bottom of the Action List 111 (left), it is clicked once so that it is selected. A dot 114, which can be red in color for easy identification, appears next to the tool 102b to indicate that it is active. The cursor 116 is moved to the application window with a wire 118 connecting the tool 102b to the cursor 116. The cursor is then moved to the intended target location, such as a graphic, text box, and the like, in the Application pane 108 at the right and then is clicked once. In this example, the button 140, labeled “Choose ID”, is selected for being acted upon by the Click Tool 102b.

The authoring component 60 analyzes the target, i.e. the button 140 in this case, and identifies its unique attributes. As shown in FIG. 15, the Click Tool settings window 142 opens in the Application pane 108 and a highlight 144 appears around the identified target 140. The Click Tool settings window 142 has four tabs: Click Picker 146 (for re-picking targets), Click Settings 148 and Events 128. The events tab 128 is the same for all of the tools, as mentioned above. In the Description box 150, an Action name is assigned that will be meaningful when it appears in the Action List 111. The “Pick New” buttoh 132 permits a new target to be picked.

In FIG. 15, it is possible to directly enter the unique HTML ID in box 152 for the selected object 140 to ensure that the programmed assistance will follow the object 140 no matter where it appears on the web page 56 or on the entire web site. The object 140 is preferably uniquely identified by its HTML ID tag but can also be uniquely identified by one or more of the following characteristics of the web object: URL hyperlink, ALT text tag, existence of adjacent objects, location and size, as described in detail above. This unique identification a web object 100, such as button 140, is described in detail above.

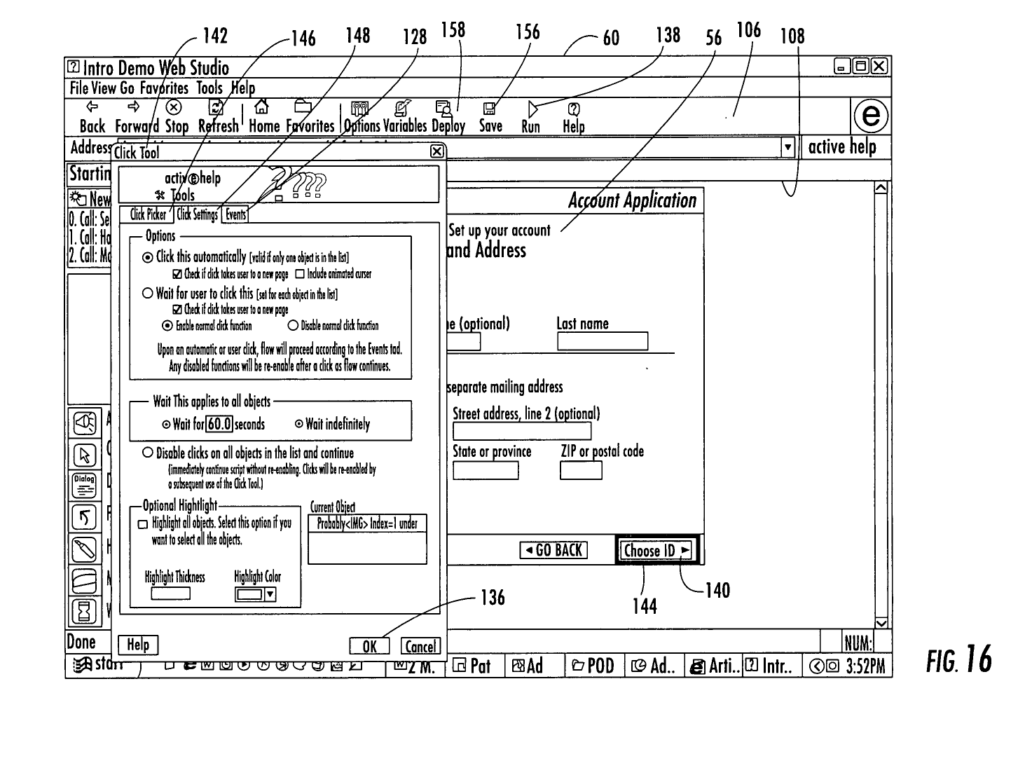

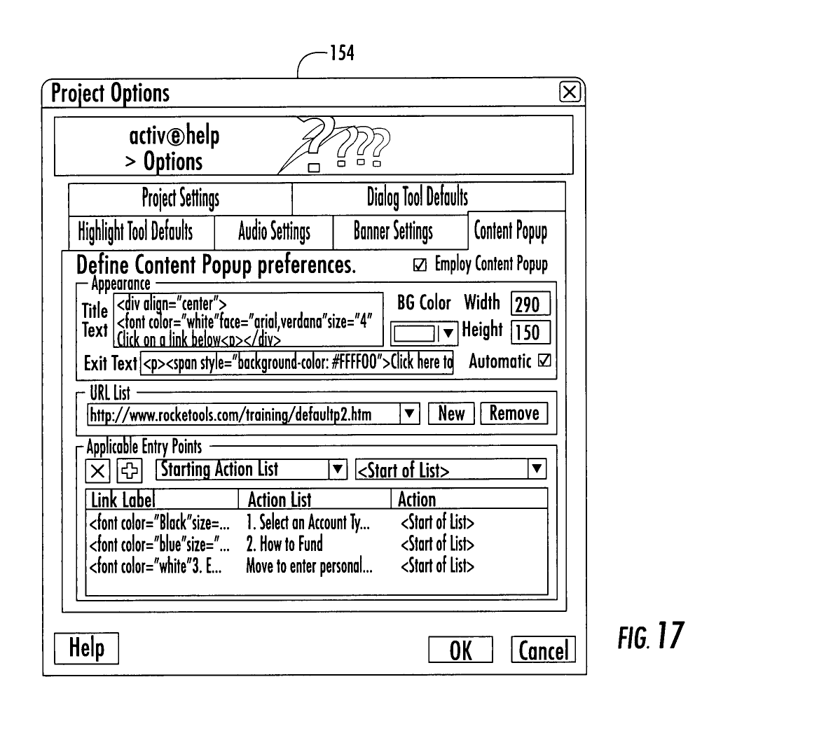

As seen in FIG. 16, the Click Settings tab 148 in the Click Tool setting window 142, which is the second tab, includes options for varies characteristics for control of the clicking of the selected web object 140. Again, setting on the Events tab 128 is used to determine what will happen after the highlight is displayed.

When the overall profile of attributes of the Click Action relating to the button 140, entitled “Choose ID”, clicking OK button 136 saves it to the Action List 111. Clicking on the Run button 138 in the toolbar 106 above the Application pane 108 tests the Click control that was just created.

Therefore, the Click Tool 102b is very powerful because allows for complete monitoring control over the execute of clicks on an application page 56. For example, it can temporarily disable the copy of the page 56 in the user's browser 58 so that the user can not inadvertently click on a web object 100. It can re-purpose a click that a user makes so that it executes an alternative event, such as presenting a message or launching a video instead of what it was designed to do in the original application. Further, it can disable objects 100 that have rollover effects (where something changes, appears, or disappears when the mouse rolls on or off the object) by invalidating the selected object's HTML OnMouseOver and OnMouseOut events or other similar types of events (onMouseDown, OnMouseUp, etc.). If a user clicks on an unmonitored target object 100 it will function as usual. A target 100 can be any object on the page 56 that performs an action when clicked upon, such as a submit button, a reset button, or a hyperlink, and the like.

Still further, another way that a web page 56 can be controlled with the method of the present invention is by use of a content pop up window 68, as seen in FIGS. 5 and 6. The show content that is created is deployed as a single JavaScript file. Within that file, Flow Tool Actions, dialogs with multiple choices, events and other techniques can be used, in accordance with the present invention, to control how and when various pieces of that content run. It is also possible to give the user control over what happens by accompanying the deployed content with a Content Popup 68. The Content Popup 68 is a separate instance of browser 58 that appears as part of the show. It preferably displays in the upper-left corner of the user's screen and its size and appearance can be customized. As can be seen in the content pop up box setting window 154 in FIG. 17, a content pop up box 68 has many customizable characteristics, such as its aesthetic appearance, target URL and entry points to a particular Action List item.

The user can move it to a new location on the screen where it will remain as the user moves from page to page within the application. The show's author decides whether to have Content Pop ups 58 in their show. Content Pop ups 68 typically contain a menu of support links but can contain other items. Referring back to FIG. 5, each link 68a, 68b, 68c, is mapped to an existing Action in an Action List 111 within the show. When the Content Popup 68 launches, it appears in the foreground and waits for the user's request. When the user clicks on a link 68a-c in the Popup 68, the Popup 68 goes into the background and the show executes the Action to which the link is mapped. When finished, the Popup 58 returns to the foreground to offer support again.

For example, as seen in FIG. 5, a content pop up box 68 provides assistance the user in navigation the web page 56. In this case, links 68a-c are dynamically provided for either selecting an account type, choosing initial funding or entry of personal details. It should also be noted that Content Popup 68 is Section 508 compliant, which requires that Federal agencies' electronic and information technology be accessible to people with disabilities. It can present direct links to Action Lists 110 within the deployed show embodied in the JavaScript file.

The Dialog Tool 102c allows the display text messages during the course of the delivery of a show. The user may be prompted for responses to questions, and then tailor the flow of the show based on the reply. The Dialog Tool 102c displays text and can prompt users to enter responses. Dialogs, such as the dialog 70 in FIG. 6, may also be animated or displayed with a 3D graphic to provide additional impact to get the user's attention.

Highlight 78, as seen in FIG. 7, and click control as well as the delivery of pop up boxes 68 with sequential control by the Flow Tool 102d, provide the core of the authoring to create deployable JavaScript file. In view of the foregoing, each of the tools 102a-g performs a specific type of Action, such as highlighting objects 100 or displaying text boxes for the user. Once a tool 102a-g is linked to a target object in the Application pane 108 to create an Action 111, all that is needed it to tell the tool 102a-g the specifics of the action that needs to be performed. The use of the other tools listed above are similar to the highlight tool 102e and the click tool 102b and the creation of content pop up boxes 68.

When all of the desired web objects 100 are linked as desired, the entire project is saved (with an AHW extension, for example) by clicking on the Save button 156 in the Studio Tool Bar 106 or pressing CTRL+S. Clicking on File in the Studio Menu Bar 106 and then clicking Save or Save As will also save the show.

Once the show is saved, the next step is to test it. This is executed by playing the show from the authoring component by pressing the “Run” toolbar button 138 on the main toolbar 106. The show (or the Active Action List 110) will run against the application page(s) 56 in the Application Pane 108.

Clicking the Deploy button 158 on the toolbar 106 combines the list of programmed Actions 111 with core authored code and writes the whole as a JavaScript file for use with application or web pages 56 as an interactive show to support or train users or to run the web site in demonstration mode. The JavaScript file is saved with a selected name with a .js extension so as to be JavaScript compliant. When desired, the JavaScript code is then launched as described above either by manual launching by the user, automatic launching when the browser opens, launching from another web page or via a custom browser.

In view of the foregoing, the present invention provides a new and unique method of controlling web page navigation by a user. Web pages 56 are initially created so that they act and react in certain ways when navigated by a user. The method of the present invention easily modifies the web page 56 displayed in the client browser without altering the underlying HTML source code of the page 56. The JavaScript program controls the overall navigation experience according to a pre-programmed set of Actions 111 and user interface elements.

The authoring component 60 of the invention enables a person to easily create the JavaScript assist program according to the desired help or demonstration features that are desired. Most importantly, each of the web objects 100, that are linked to a particular event and action, are uniquely and specifically identified so that a given event or action is executed upon interaction with a web object 100 regardless of where that web object 100 appears on the web page 56 or web site. Thus, the control of navigation of web objects 100 survives across web pages 56 even if those underlying web pages 56 are modified.

It would be appreciated by those skilled in the art that various changes and modifications can be made to the illustrated embodiments without departing from the spirit of the present invention. All such modifications and changes are intended to be covered by the appended claims.

What is claimed is:

1. A method of controlling navigation of a web site by a user, comprising the steps of:
providing a web page having a web object thereon;
defining a navigation action upon interaction of the web object by the user; creating and storing a set of action parameters based on the navigation action;
launching an assist program programmed with the set of action parameters;
executing the navigation action by the assist program upon interaction of the web object by the user.

2. The method of claim 1, wherein the web page includes a plurality of web objects thereon.

3. The method of claim 2, further comprising the steps of:
defining a plurality of navigation actions corresponding respectively to the plurality of web objects;
executing the plurality of navigation actions upon interaction by the user with the corresponding web object.

4. The method of claim 1, wherein the assist program is written in a cross-platform language.

5. The method of claim 1, wherein the assist program is written in JavaScript.

6. The method of claim 1, wherein the navigation action is highlighting a specific web object.

7. The method of claim 1, wherein the navigation action is playing an audio file.

8. The method of claim 1, wherein the navigation action is disabling mouse clicks in connection with the web object.

9. The method of claim 1, wherein the navigation action is displaying a text box.

10. The method of claim 1, wherein the navigation action is displaying a dialog box.

11. The method of claim 1, wherein the navigation action is writing text into a field in a form.

12. The method of claim 1, wherein the navigation action is directing the user to another web page.

13. A method of controlling navigation of a web site by a user, comprising the steps of:
establishing a connection between a server machine and a client machine over a network; the client machine having a visual display and a input means for interacting with the client machine by the user;
receiving web page information from the server machine over the network; the web page information including a web object thereon;
uniquely identifying the web object as a single specific web object on the web page;
defining a response action to be taken upon interaction with the single specific web object;
displaying on the visual display of the client machine the web page with the specific web object thereon;
receiving input from the user via the input means to interact with the web specific object on the web page;
monitoring the input from the user;
determining whether the input from the user interacts with the specific web object; and
executing the response action upon interaction with the specific web object by the input from the user.

14. The method of claim 13, wherein the web page includes a plurality of uniquely identifiable specific web objects thereon.

15. The method of claim 14, further comprising the steps of:
defining a plurality of response actions corresponding respectively to the plurality of specific web objects;
executing the plurality of response actions upon interaction by the user with the corresponding specific web object.

16. The method of claim 13, wherein the assist program is written in a cross-platform language.

17. The method of claim 16, wherein the assist program is written in JavaScript.

18. The method of claim 13, wherein the input means is a keyboard and mouse.

19. The method of claim 13, wherein the response action is highlighting the specific web object.

20. The method of claim 13, wherein the response action is playing an audio file.

21. The method of claim 13, wherein the response action is disabling mouse clicks by a user in connection with the specific web object.

22. The method of claim 13, wherein the response action is disabling all mouse clicks by a user.

23. The method of claim 13, wherein the response action is displaying a text box.

24. The method of claim 13, wherein the response action is displaying a dialog box.

25. The method of claim 13, wherein the response action is writing text into a field in a form.

26. The method of claim 13, wherein the response action is directing the user to another web page.

27. A method of authoring a cross-platform program file, comprising the steps of:
displaying a web page with a web object thereon;
uniquely identifying the web object thereon;
selecting an action to be taken;
linking the action to be taken with the web object;
saving a cross-platform file having information regarding the action to be taken on the specific web object.

28. The method of claim 27, wherein the step of uniquely identifying the web object includes identifying the HTML ID tag of the web object.

29. The method of claim 27, wherein the step of uniquely identifying the web object includes identifying distinctive parameters of the web object that are different than other web objects on the web page.

30. The method of claim 29, wherein the distinctive parameters of the web object are one or more items selected from the group consisting of; size, location, adjacent objects, URL and alternative text data.

31. The method of claim 27, wherein the web page is written in HTML language.

32. The method of claim 27, wherein the cross-platform file is written in JavaScript.
